(19) United States
(12) Patent Application Publication
(10) Pub. No.: US 2017/0150197 A1
(43) Pub. Date: May 25, 2017

(54) MULTIMEDIA CONTENT SHARING AND DISTRIBUTION

(71) Applicant: Nady International Limited

(72) Inventor: Artak J. Zograbian, Shelekhov (RU)

(21) Appl. No.: 14/947,682

(22) Filed: Nov. 20, 2015

(51) Int. Cl. H04N 21/2543; H04N 21/4784; H04N 21/45; H04N 21/258; H04N 21/442; H04N 21/472

(52) U.S. Cl. CPC H04N 21/2543; H04N 21/44222; H04N 21/472; H04N 21/4532; H04N 21/4524; H04N 21/25841; H04N 21/4784

(57) ABSTRACT

A multimedia sharing and distributions system is provided to facilitate requesting and distributing multimedia content. A first user, using a computing device, can make an offer for multimedia content and a second user can accept the offer to provide multimedia content. The multimedia content can then be generated by the second user and uploaded to the multimedia sharing and distribution system which then can stream the multimedia content to the first user's device. In an embodiment, the offer can be published on a multimedia sharing platform and can specify a location and a time associated with the request for multimedia content. A multimedia content producer can browse through the published requests and search for locations that match his/her location. In an embodiment, the multimedia content producer can also be notified when matching requests are made.

### TECHNICAL FIELD

The subject disclosure relates to streaming and distributing multimedia content using distributed computing devices.

### BACKGROUND

With the proliferation of mobile devices with video and audio recording capabilities and of digital cameras that are network connected, the multimedia generation capacity of devices around the world is orders of magnitude higher than it was just a decade ago, creating an unimaginable and staggering complexity and scale of globally connected devices, but also tremendous opportunity. This multimedia generation capacity is going at least partially unused, however, as devices are often inactive or the device owner may not have an interest in recording multimedia at any given moment. Likewise, users who may want to consume multimedia content of an event or other specifiable circumstance may be unable to do so as they may be far from the location of the event.

### BRIEF DESCRIPTION OF THE DRAWINGS

FIG. 1 is an example, non-limiting embodiment of a block diagram showing a multimedia content sharing and distribution system in accordance with various aspects described herein.

FIG. 2 is an example, non-limiting embodiment of a block diagram showing a multimedia content sharing and financial payments system in accordance with various aspects described herein.

FIG. 3 is an example, non-limiting embodiment of a block diagram showing a multimedia content sharing and content distribution system in accordance with various aspects described herein.

FIG. 4 is an example, non-limiting embodiment of a block diagram showing a multimedia sharing and distribution platform in accordance with various aspects described herein.

FIG. 5 is an example, non-limiting embodiment of a block diagram showing a multimedia sharing and distribution platform in accordance with various aspects described herein.

FIG. 6 illustrates a flow diagram of an example, non-limiting embodiment of a method for sharing and distributing multimedia content as described herein.

FIG. 7 illustrates a flow diagram of an example, non-limiting embodiment of a method for sharing and distributing multimedia content as described herein.

FIG. 8 illustrates a flow diagram of an example, non-limiting embodiment of a method for sharing and distributing multimedia content as described herein.

FIG. 9 illustrates a flow diagram of an example, non-limiting embodiment of a method for sharing and distributing multimedia content as described herein.

FIG. 10 illustrates a flow diagram of an example, non-limiting embodiment of a method for sharing and distributing multimedia content as described herein.

FIG. 11 is a block diagram of an example, non-limiting embodiment of a computing environment in accordance with various aspects described herein.

FIG. 12 is a block diagram of an example, non-limiting embodiment of a mobile network platform in accordance with various aspects described herein.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with multimedia content sharing and distribution. For instance, an embodiment includes a system comprising a processor and a memory that stores executable instructions that, when executed by the processor, facilitate performance of operations. The operations can include receiving a request for multimedia content, wherein the request comprises metadata information relating to a location and a time associated with requested multimedia content, content information describing the requested multimedia content, and reward information. The operations can also include forwarding the request to a set of multimedia content producers, wherein the set of multimedia content producers is determined based on matching or substantially matching a set of locations of the set of multimedia content producers to the location in the request for the multimedia content. The operations can also include receiving, via a digital upload from a producer user device associated with a multimedia content producer of the set of multimedia content producers, multimedia content associated with the request for multimedia content. The operations can also include streaming the digital multimedia content to a requestor user device of a user account associated with the request for multimedia content. The operations can also include initiating payment to the multimedia content producer in response to receiving the digital upload by the requestor user device, wherein the payment is based on the reward data in the request for multimedia content.

In another non-limiting embodiment, a method can include receiving, by a network device comprising a processor, a request for video content comprising a description of requested video content, a location associated with the requested video content, and a time associated with the requested video content. The method can also include publishing, by the network device, the request for video content on a request board that is searchable based on the description, the location, and the time of the requested video content. The method can also include receiving, by the network device, digital video content from a producer user device associated with a video content producer account, wherein the digital video content corresponds to the requested video content. The method can also include streaming, by the network device, the digital video content to a requestor user device associated with a video content requestor account.

In another non-limiting embodiment, a machine-readable storage medium can comprise executable instructions that, when executed by a processor, facilitate performance of operations. The operations can include receiving a request for multimedia content from a multimedia content requestor, wherein the request comprises metadata information relating to a first location and a time associated with requested multimedia content and content information describing the requested multimedia content. The operations can also include forwarding the request to a set of multimedia content producers, wherein the set of multimedia content producers is determined based on mapping a set of locations of the set of multimedia content producers to the location in the request for the multimedia content according to a defined closeness condition between the set of locations and the location being determined to be satisfied. The operations can further include receiving a notification comprising an acceptance of the request for multimedia content from a producer device associated with a multimedia content producer of the set of multimedia content producers and forwarding the notification comprising the acceptance to a requestor device associated with the multimedia content requestor and receiving, via a digital upload from the producer device, multimedia content associated with the request for multimedia content. The operations can also include streaming the digital multimedia content to the requestor device.

In another non-limiting embodiment, a system can include a processor; and a memory that stores executable instructions that, when executed by the processor, facilitate performance of operations. The operations can include receiving a digital upload offer from a producer user device associated with a multimedia content producer account, wherein the digital upload offer comprises offer information associated with multimedia content, first metadata information relating to a location and a time associated with the multimedia content, content information describing the multimedia content, and price information. The operations can also include receiving a request for multimedia content from a requestor user device associated with a multimedia content requestor account, wherein the request for multimedia content comprises second metadata information comprising a location and a time associated with requested multimedia content, content information describing the requested multimedia content. The operations can also include matching the request for multimedia content to the digital upload based on matching the first metadata information and the second metadata information and receiving a digital upload corresponding to the multimedia content from the producer user device. The operations can also include streaming the digital upload to the requestor user device and initiating payment to the multimedia content producer account in response to receiving an acceptance notification from the requestor user device, wherein the payment is based on the price information in the digital upload.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

A multimedia sharing and distributions system is provided to facilitate requesting and distributing multimedia content between users around the world. A first user, using a computing device, can make an offer for multimedia content and a second user can accept the offer to provide multimedia content. The multimedia content can then be generated by the second user and uploaded to the multimedia sharing and distribution system which then can stream the multimedia content to the first user's device. The multimedia sharing and distribution system can also facilitate payments for the multimedia content. In an embodiment, the offer can be published on a multimedia sharing platform and can specify a location and a time associated with the request for multimedia content. A multimedia content producer can browse through the published requests and search for locations that match his/her location. In an embodiment, the multimedia content producer can also be notified when matching requests are made.

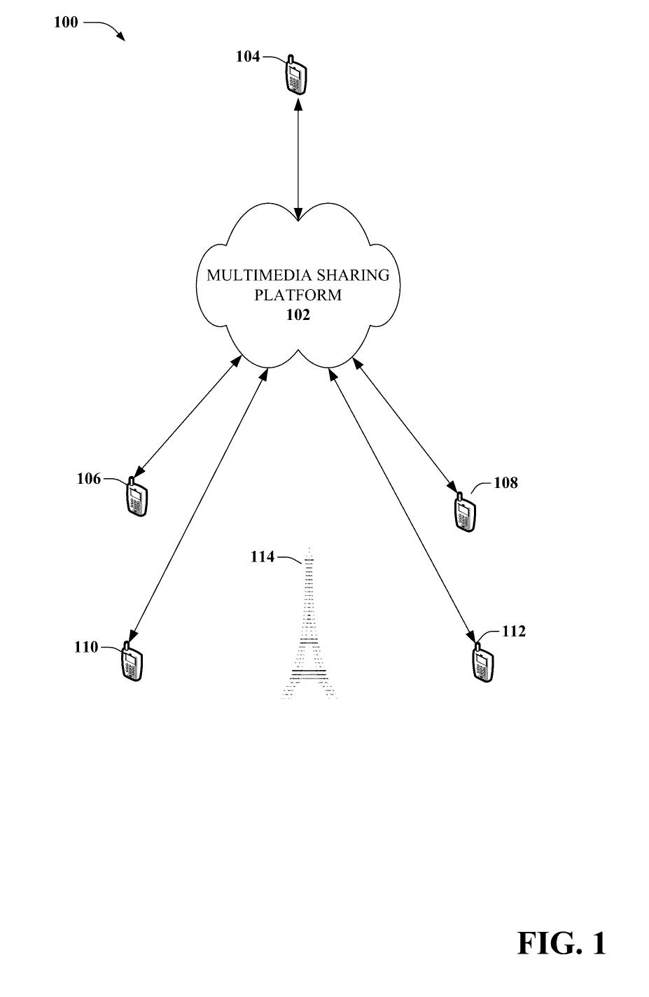

Turning now to FIG. 1, illustrated is an example, non-limiting embodiment of a block diagram showing a multimedia content sharing and distribution system 100 in accordance with various aspects described herein. The multimedia content sharing and distribution system 100 can include a multimedia sharing platform 102 that can facilitate sharing and distributing created multimedia content between devices 104, 106, 108, 110, and 112. The multimedia sharing platform can be a cloud based service platform that is accessible by the devices 104-112 via a wireless or wireline network. The device 104-112 can be mobile devices such as cellular phones, or other cellular enabled devices. The devices 104-112 can also be WiFi enabled devices such as portable tablets or laptops or other computing devices. In other embodiments, the devices 104-112 can be cameras or video digital recorders that can be network communication capable in some embodiments.

The mobile broadband network can generally comprises a radio access network that facilitates communications between the mobile devices and a core network. In the case of Long Term Evolution (“LTE”) networks and other 3rd Generation Partnership Project (“3GPP”) compliant networks (e.g., LTE Advanced) and even non-3GPP systems such as WiMAX and CDMA2000, these networks are the radio access network and an evolved packet core network that can contain a series of components that provide mobile data and control management. WiFi networks as disclosed herein can include any networks that are compliant with IEEE 802.11 protocols. Wireline networks as disclosed herein can include passive optical networks, Ethernet, DSL (Digital Subscriber Line), cable, and other methods of providing communications over wired interfaces.

In an embodiment, a device 104 can be associated with a multimedia content requestor account. A user can sign up for an account using the device 104 or another device and specify whether the account is to be a requestor account or provider account. Requestor accounts can configured to make multimedia content requests while Provider accounts can be configured to provide created multimedia content. In some embodiments, user accounts can be both requestor and provider accounts simultaneously, or at varying times. The multimedia sharing platform 102 can be accessed on the devices 104-112 via an application that is installed on the devices. In other embodiments, the multimedia sharing platform 102 can be accessed via a browser or other pre-existing application on the devices 104-112. The accounts can include financial information of financial institutions associated with the user such as bank accounts, routing numbers, credit card numbers, and other financial information that can be used to facilitate payments to and from the devices 104-112.

In an embodiment, the device 104 can be associated with a multimedia content requestor account, and devices 106, 108, 110, and 112 can be associated with multimedia content provider accounts. Device 104 can send a request for multimedia content to multimedia sharing platform 102 specifying what multimedia content is requested, e.g. location, event, object, etc. For instance, in the embodiment shown in FIG. 1, the multimedia content request can indicate that multimedia content involving the Eiffel Tower 114 is requested. The multimedia request can also specify a desired time of multimedia content recording (e.g., such as a limited in time event like a laser light show involving the Eiffel Tower). In some embodiments, if the location is not specified, but the request has other specifics (e.g., multimedia content requested comprises video of a dog chasing a stick), the request can still include a location field, but the field can be empty, or have a null value.

In an embodiment, the multimedia sharing platform 102 can select which devices to notify about the request based on matching the location of the devices and location specified. The multimedia sharing platform 102 can receive location information from each of the devices 106-112 directly in the form of coordinates or based on the IP address, or other qualitative measures of location (e.g., zip code, city, country, etc). In other embodiments, the multimedia sharing platform 102 can receive the location information from the mobile broadband network associated with the devices 106-112. The multimedia sharing platform can send a notification or alert about the request to all devices that are within a predetermined distance from the Eiffel Tower 114 that have signed up for an account with the service provided by the multimedia sharing platform. In other embodiments, the multimedia sharing platform can publish the request for multimedia content on the platform 102, and devices 106-112 can search through requests based on location, distance, time, multimedia type, and one or more keywords.

In another embodiment, the multimedia sharing platform 102 can select to which devices to send the request notification based on prior multimedia uploads. For instance, devices 106, 108, 110, and 112 can be selected based on prior multimedia uploads matching one or more styles that the multimedia requestor has requested or consumed in the past. The multimedia sharing platform 102 can perform video classification analysis on prior multimedia uploads and classify the video uploads into one or more styles, and if the multimedia requestor account has consumed multimedia matching one of those styles or expressed interest in those styles, multimedia sharing platform 102 can select devices based the previous uploads.

The request for multimedia content can also include information about a reward, associated with the request for multimedia content. In an embodiment, the reward can be a monetary value that can be paid upon delivering multimedia content. In other embodiments, the reward can be non-monetary value including services or trade in-kind, credits, or other valuable consideration. In an embodiment, the reward information can specify what percentage can be paid upon accepting the request to provide multimedia content and what percentage is to be paid upon completion. In other embodiments, the reward information can also include information about penalties associated with accepting and then not delivering multimedia content.

In some embodiments, the request from device 104 can also include information about whether the request for multimedia content is private or public. If public, the request, once published can be searchable or viewable by anybody with an account, or without an account in some embodiments. If the request is private, the request may be limited to people with accounts, or people matching one or more criteria specified in the request (e.g., location, content provider type, device type, etc).

In an embodiment, the multimedia sharing platform 102 can send a notification, or alert, to the user device 104 when a predetermined amount of time has passed without another user accepting the request for multimedia content. In other embodiments, the multimedia sharing platform 102 can send a notification to the user device 104 if the time specified for the request is approaching, or is within another predetermined amount of time. In some embodiments, the multimedia sharing platform can send reminders to the devices 106, 108, 110, and 112 if the request has not been accepted within a certain amount of time after being made, or once again, if the time for the event is approaching.

In an embodiment, if a user of one of the devices 106-112 is interested in accepting the offer, the device, e.g., device 106, will send an acceptance to the multimedia sharing platform 102 which can then forward the acceptance to device 104. Upon acceptance, the multimedia sharing platform 102 can remove the request listing so that other devices cannot accept it, or will mark the request as “pending”. Upon acceptance, a portion of the reward can be paid to the device 106 or the account associated with device 106.

In some embodiments, the device 106 can send filter data to the multimedia sharing platform to list all requests that conform to the filter data. The filter data can include information such as location, time, type of equipment, multimedia style, and other keywords that may be relevant to the multimedia content producer. In some embodiments, the filter data can be manually entered by the multimedia content producer, and in other embodiments, the filter data can be auto-filled by the device 106.

In an embodiment, the multimedia sharing platform 102 can select content to list for device 104 based on quality rankings associated with each of the user devices 106, 108, 110, and 112. These quality rankings can be based on previous feedback received from other requestors. The user device 104, after streaming the content, can also send a quality ranking to the multimedia sharing platform 102 ranking the quality of the streamed digital content.

After accepting the request for multimedia content, the user device 104 can agree to the offer, and user device 106 can start obtaining and/or recording multimedia content. In other embodiments, the user device 106 can start recording multimedia content without user device 104 agreeing to the acceptance. The multimedia content recorded can include video and/or audio recordings recorded by the user device, or recorded by another recording device. If recorded by another recording device, such as a camera or microphone device, the digital file(s) comprising the recording can be transferred to the user device 106. The user device 106 can upload the multimedia content to the multimedia sharing platform, which can then make the digital multimedia content available to device 104. In some embodiments, user device 106 can upload the digital multimedia content to a content distribution network that is separate from the multimedia sharing platform. User device 104 can then access the multimedia content from the content distribution network.

In some embodiments, user device 104 can access the multimedia content from multimedia sharing platform 102 via downloading the one or more digital files/content. In other embodiments, user device 104 can stream the digital content from multimedia sharing platform. In some embodiments, user device 104 can watch the content after the multimedia content has been fully uploaded at some later time or date. In other embodiments however, user device 104 can stream the multimedia content in real time, or substantially real time as the multimedia content is uploaded. In other embodiments, user device 104 can stream the multimedia content directly from user device 106.

In an embodiment, the multimedia content can include sensor data that is transmitted with the audio and/or visual recordings. This sensor data can include motion data obtained from one or more accelerometers on user device 106 or from GPS information or other network location information. The sensor data can also include data about external environmental conditions such as temperature data, atmospheric pressure data, humidity data, etc. This data can be used to provide context about the multimedia content.

In other embodiments, the user device 104 while streaming or viewing the digital multimedia content can send instructions for user device 106 via the multimedia sharing platform. The instructions can be for the user of the device 106 to change viewing angles, zoom, or some other instruction related to operation of the user device and recording of the audio and/or visual content. For instance, if the user of device 104 is viewing the multimedia content, but desires a different angle, or other change in the operation of the device 106, the user of device 104 can send an instruction to change the operation of device 106.

In an embodiment, if the user device 106 has sent a consent notification to operation change, device 104 can send a control signal that will automatically change operation of the device 106. The control signal can affect an operation performed by device 106 that can change the zoom, pan/tilt operation, focus, audio pickup, and etc., of device 106. In an embodiment, the user device 104 can send a request to control notification to the user device 106 via the multimedia sharing platform 102, and user device 106 can respond with a negative or an affirmative response, disallowing or allowing the device 104 to send a control signal.

In an embodiment, the multimedia sharing platform 102 can combine multimedia content uploads from two or more devices (e.g., device 106 and device 108). The combination can be performed in response to a request from device 104 to combine. In some embodiments, one of the devices can provide a video stream, while another device provides an audio stream. In other embodiments, the device 104 can stream from multimedia sharing platform 102 a split screen multimedia showing two different views or perspectives of an object or event.

In an embodiment, the marketplace provided by the multimedia sharing platform 102 can be reversed, and one or more of user devices 106, 108, 110, or 112 can upload digital multimedia content of object or event 114 to multimedia sharing platform 102 without responding to a request from user device 104. Instead, the user device 106, can for example, upload digital multimedia content that includes the digital multimedia and metadata information that describes the content, provides the time and location of the content. The digital upload can also include price information representing the asking price of the content. When user device 104 sends a request for multimedia content, the multimedia sharing platform 102 can match the request to the already uploaded multimedia content based on the matching the location and time, and other content information. If requestor device 104 accepts the content, the digital content can begin streaming to the user device 104 and payment can be initiated to the user device 106 and/or account associated with device 106.

In some embodiments, one or more of user devices 106, 108, 110, or 112 can upload an offer to produce digital multimedia content of object or event 114 to multimedia sharing platform 102. If requestor user device 104 accepts the offer, then the device that offered to produce the digital multimedia content can produce the content, and then upload the digital content to the multimedia sharing platform 102 for streaming to device 104.

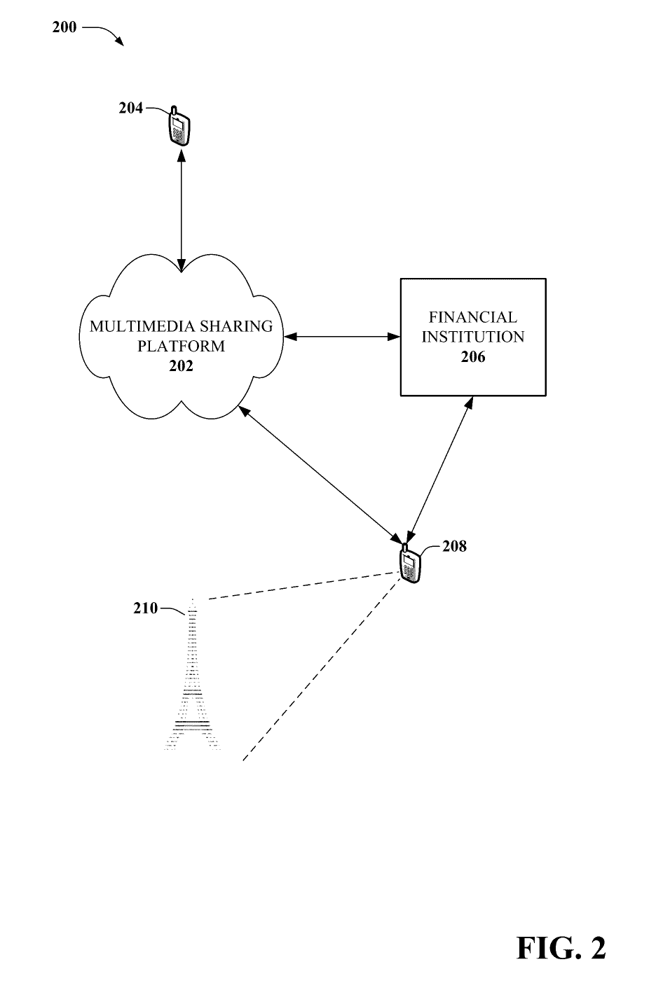

Turning now to FIG. 2, illustrated is an example, non-limiting embodiment of a block diagram showing a multimedia content sharing and financial payments system 200 in accordance with various aspects described herein.

The multimedia content sharing and distribution system 200 can include a multimedia sharing platform 202 that can facilitate sharing and distributing created multimedia content between devices 204 and 208 regarding an object or event requested by device 204 (e.g., Eiffel Tower 210). The multimedia sharing platform 202 can be a cloud based service platform that is accessible by the devices 204 and 208 via a wireless or wireline network. The device 204 and 208 can be mobile devices such as cellular phones, or other cellular enabled devices. The devices 204 and 208 can also be WiFi enabled devices such as portable tablets or laptops or other computing devices. In other embodiments, the devices 204 and 208 can be cameras or video digital recorders that can be network communication capable in some embodiments.

In an embodiment, a device 204 can be associated with a multimedia content requestor account. A user can sign up for an account using the device 204 or another device and specify whether the account is to be a requestor account or provider account. Requestor accounts can configured to make multimedia content requests while Provider accounts can be configured to provide created multimedia content. In some embodiments, user accounts can be both requestor and provider accounts simultaneously, or at varying times. The multimedia sharing platform 202 can be accessed on the devices 204 and 208 via an application that is installed on the devices. In other embodiments, the multimedia sharing platform 202 can be accessed via a browser or other pre-existing application on the devices 204 and 208. The accounts can include financial information related to financial institution 206 associated with the user such as bank accounts, routing numbers, credit card numbers, and other financial information that can be used to facilitate payments to and from the devices 204 and 208.

In an embodiment, upon device 204 making a request for multimedia content, multimedia sharing platform 202 can check financial institution 206 to determine that the funds specified in the request are available for payment. In an embodiment, the multimedia sharing platform 202 can withdraw a portion or all of the payment before device 208 has accepted request to provide multimedia content. The portion of the money withdrawn by multimedia sharing platform 202 can be reserved associated with the account associated with device 204.

In an embodiment, another portion (e.g., 20%) of the money can be transferred to the account associated with device 208 when device 208 sends a notification accepting the request to provide multimedia content. The remainder of the money can be transferred to the account of device 208 when the multimedia content is uploaded to the multimedia sharing platform 202 from device 208, or when device 204 streams or accepts the multimedia content from multimedia sharing platform 202. In other embodiments, the full amount of the financial transfers can be transferred at the end of the transaction.

In some embodiments, multimedia sharing platform 202 can facilitate payments from the financial institution 206 directly to an account associated with device 208. Such payments can include payments to digital wallets associated with the device 208. Payments from financial institution can include monetary payments, but can also include other payments that have value, such as bitcoin transfers and other digital, electronic, and cryptocurrencies.

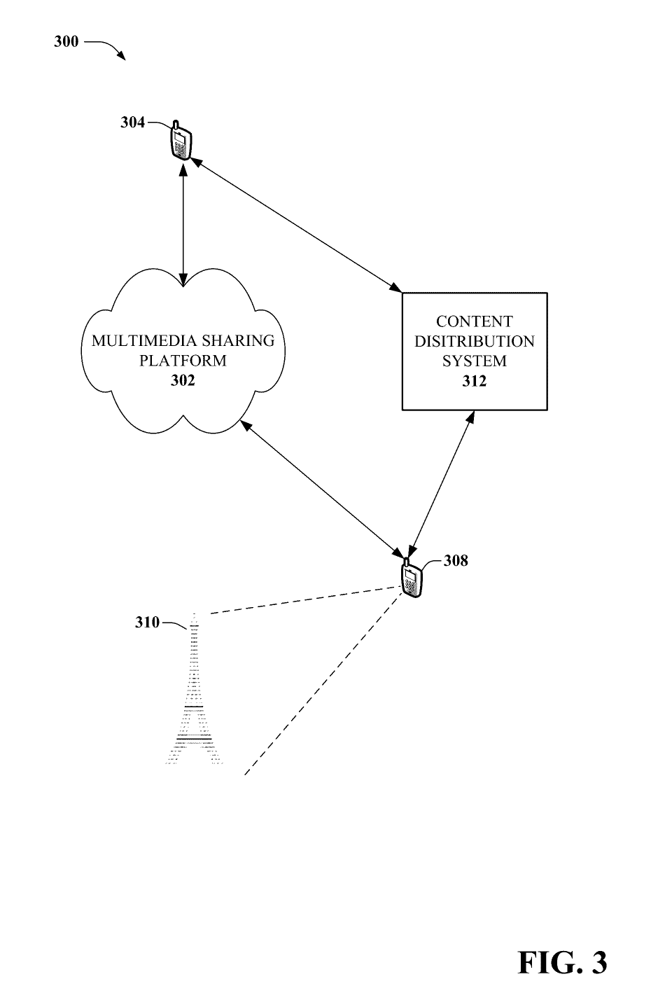

Turning now to FIG. 3, illustrated is an example, non-limiting embodiment of a block diagram showing a multimedia content sharing and content distribution system 300 in accordance with various aspects described herein.

The multimedia content sharing and distribution system 300 can include a multimedia sharing platform 302 that can facilitate sharing and distributing created multimedia content between devices 304 and 308 regarding an object or event requested by device 304 (e.g., Eiffel Tower 310). The multimedia sharing platform 302 can be a cloud based service platform that is accessible by the devices 304 and 308 via a wireless or wireline network. The device 304 and 308 can be mobile devices such as cellular phones, or other cellular enabled devices. The devices 304 and 308 can also be WiFi enabled devices such as portable tablets or laptops or other computing devices. In other embodiments, the devices 304 and 308 can be cameras or video digital recorders that can be network communication capable in some embodiments.

In an embodiment, a device 304 can be associated with a multimedia content requestor account. A user can sign up for an account using the device 304 or another device and specify whether the account is to be a requestor account or provider account. Requestor accounts can configured to make multimedia content requests while Provider accounts can be configured to provide created multimedia content. In some embodiments, user accounts can be both requestor and provider accounts simultaneously, or at varying times. The multimedia sharing platform 302 can be accessed on the devices 304 and 308 via an application that is installed on the devices. In other embodiments, the multimedia sharing platform 302 can be accessed via a browser or other pre-existing application on the devices 304 and 308.

In the embodiment shown in FIG. 3, instead of uploading and streaming the multimedia content via multimedia sharing platform 302, the device 308 can upload digital multimedia content to a content distribution system 312. The content distribution system 312 can then stream the digital multimedia content to device 304. The content distribution system 312 can provide a robust streaming service that is not reliant on multimedia sharing platform 302 except for configuration and setup information.

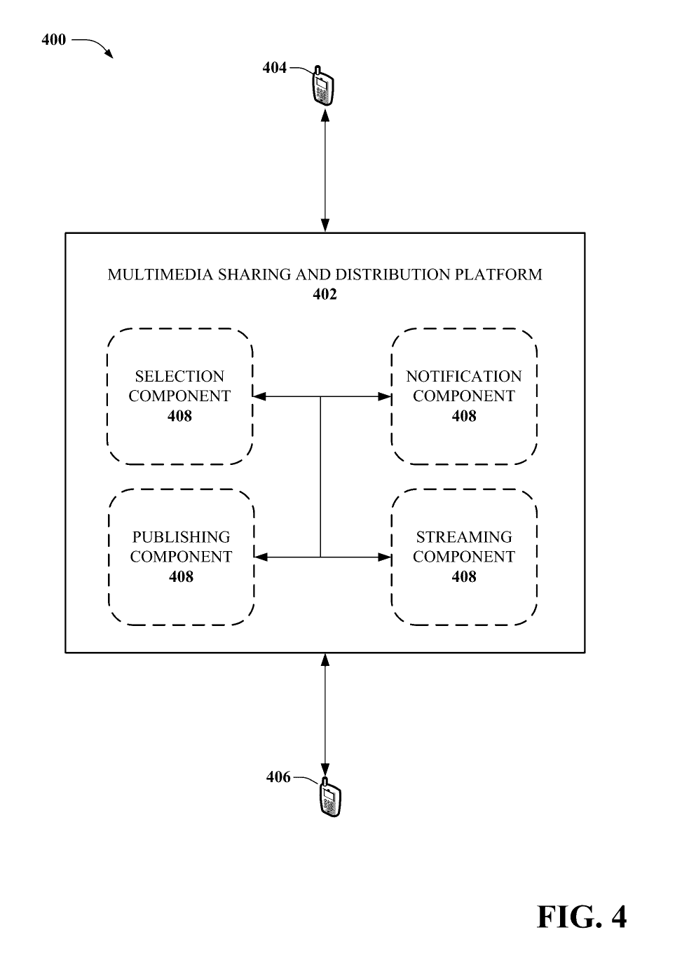

Turning now to FIG. 4, illustrated is an example, non-limiting embodiment of a block diagram showing a multimedia sharing and distribution platform system 400 in accordance with various aspects described herein. Multimedia sharing and distribution platform 402 can facilitate sharing and distributing multimedia content to and from devices 404 and 406.

User device 404 can send a request for multimedia content to the multimedia sharing and distribution platform 402 specifying what type of media is desired, the location of the media, what time to record, and other information. Publishing component 408 can publish the request in a list of other requests and also make the list searchable so that device 406 can search for requests to fulfill. Device 406 can search based on the location, the time, and other pertinent information and selection component 408 can return results that conform to the search criteria specified by the user device 406.

In some embodiments, selection component 408 can select which devices (e.g., device 406) to notify about the request based on matching the location of the device 406 and location specified in the request. The selection component 408 can receive location information from each of the device 406 directly in the form of coordinates or based on the IP address, or other qualitative measures of location (e.g., zip code, city, country, etc) associated with the requestor account or the device 404. In other embodiments, the selection component 408 can receive the location information from the mobile broadband network associated with the user device 406. The selection component 408 can send a notification or alert about the request to all devices that are within a predetermined distance from the event or subject of the requested multimedia content.

In another embodiment, the selection component 408 can select to which devices to send the request notification based on prior multimedia uploads. For instance, device 406 can be selected based on prior multimedia uploads matching one or more styles that the multimedia requestor has requested or consumed in the past. The selection component 408 can perform video classification analysis on prior multimedia uploads and classify the video uploads into one or more styles, and if the multimedia requestor account has consumed multimedia matching one of those styles or expressed interest in those styles, selection component 408 can select devices based the previous uploads.

Notification component 408 can send a notification, or alert, to the user device 404 when a predetermined amount of time has passed without another user accepting the request for multimedia content. In other embodiments, the notification component 408 can send a notification to the user device 404 if the time specified for the request is approaching, or is within another predetermined amount of time. In some embodiments, the notification component 408 can send reminders to the device 406 if the request has not been accepted within a certain amount of time after being made, or once again, if the time for the event is approaching.

The streaming component 408 can receive the digital multimedia content from device 406 and stream it to device 404. In other embodiments, user device 404 can stream the digital content from streaming component 408. In some embodiments, user device 404 can watch the content after the multimedia content has been fully uploaded at some later time or date. In other embodiments however, user device 404 can stream the multimedia content in real time, or substantially real time as the multimedia content is uploaded. In other embodiments, user device 404 can stream the multimedia content directly from user device 406.

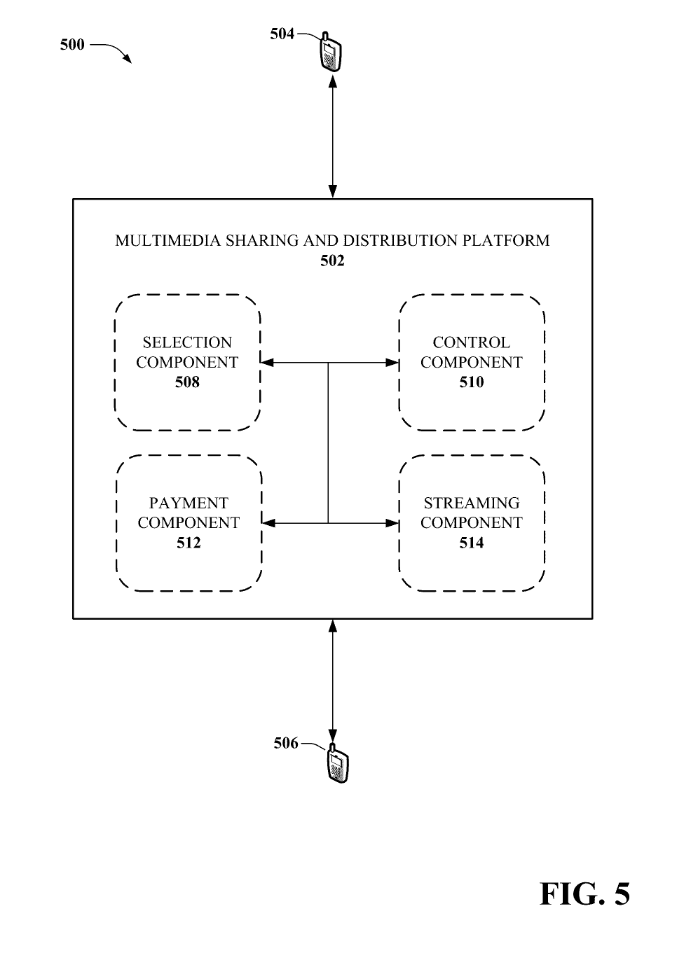

Turning now to FIG. 5, illustrated is an example, non-limiting embodiment of a block diagram showing a multimedia sharing and distribution platform system 500 in accordance with various aspects described herein. Multimedia sharing and distribution platform 502 can facilitate sharing and distributing multimedia content to and from devices 504 and 506.

User device 504 can send a request for multimedia content to the multimedia sharing and distribution platform 502 specifying what type of media is desired, the location of the media, what time to record, and other information. Selection component 408 can select which devices (e.g., device 506) to notify about the request based on matching the location of the device 506 and location specified in the request.

The multimedia sharing platform 502 can be accessed on the devices 504 and 506 via an application that is installed on the devices. The accounts associated with each of the devices 504 and 506 can include financial information of financial institutions associated with the user such as bank accounts, routing numbers, credit card numbers, and other financial information that can be used to facilitate payments to and from the devices 504 and 506.

In an embodiment, upon device 504 making a request for multimedia content, payment component 512 can check a financial institution associated with the device 504 to determine that the funds specified in the request are available for payment. In an embodiment, the payment component 512 can withdraw a portion or all of the payment before device 506 has accepted request to provide multimedia content. The portion of the money withdrawn by payment component 512 can be reserved associated with the account associated with device 504.

In an embodiment, another portion (e.g., 20%) of the money can be transferred to the account associated with device 506 when device 506 sends a notification accepting the request to provide multimedia content. The remainder of the money can be transferred to the account of device 506 when the multimedia content is uploaded to the streaming component 514 from device 506, or when device 504 streams or accepts the multimedia content from streaming component 514. In other embodiments, the full amount of the financial transfers can be transferred at the end of the transaction.

In some embodiments, payment component 512 can facilitate payments from the financial institution directly to an account associated with device 506. Such payments can include payments to digital wallets associated with the device 506. Payments from financial institution can include monetary payments, but can also include other payments that have value, such as bitcoin transfers and other digital, electronic, and cryptocurrencies.

In an embodiment, a control component 510 can manage instructions sent from device 504 to device 506. In an embodiment, if the user device 506 has sent a consent notification to operation change, device 504 can send a control signal that will automatically change operation of the device 506. The control signal can affect an operation on device 506 that can change the zoom, pan/tilt operation, focus, audio pickup, and etc., of device 506. In an embodiment, the user device 510 can send a request to control notification to the user device 506 via the control component 510, and user device 506 can respond with a negative or an affirmative response, disallowing or allowing the device 504 to send a control signal.

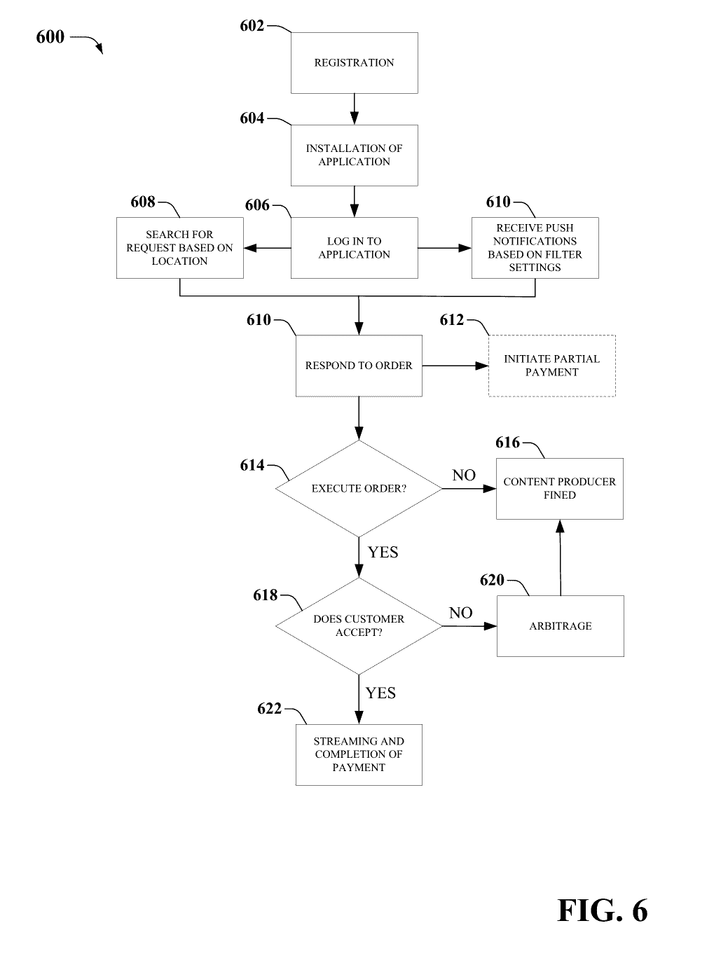

FIGS. 6-10 illustrate processes in connection with the aforementioned systems. The process in FIGS. 6-10 can be implemented for example by the systems 100-500 in FIGS. 1-5. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 6 illustrates a flow diagram of an example, non-limiting embodiment of a method 600 for sharing and distributing multimedia content as described herein. The method can start at 602, where a user device can register an account with a multimedia sharing and distribution platform. At 604, the user can install an application associated with the multimedia sharing and distribution platform on their mobile device. In other embodiments this step can be skipped as the user device can in some embodiments log into a website via a browser with needing an application.

At 606, the user can log in to the application on their device and start to discover requests for video and/or audio content which they can fulfill. In one embodiment, at 608, the user can search for requests based on their location, while in other embodiments, at 610, the user can receive notifications, push or otherwise, associated with filter settings can filter requests based on pertinent criteria such as keywords, location, time, etc.

At 610, once a request has been found that the user desires to fulfill, they can respond to the request. At this time partial payment may optionally be made to the user from the requestor at 612. At 614, if the order is accepted but not execute, the multimedia content provider can be fined at 616. If the order is accepted and executed, the requestor is given a chance to accept the order at 618. If the requestor does not accept the multimedia content, the transaction go undergo arbitrage at 620, which may result in the content producer being fined again at 616. Alternatively, if the requestor accepts the order, the multimedia platform can start streaming and completing payment at 622.

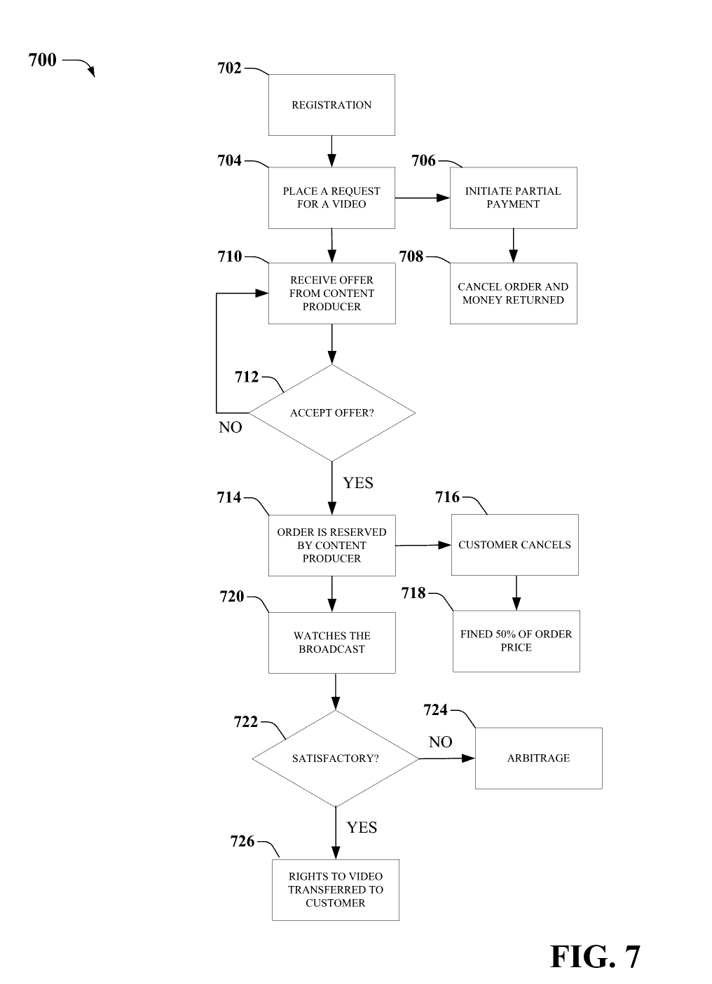

FIG. 7 illustrates a flow diagram of an example, non-limiting embodiment of a method 700 for sharing and distributing multimedia content as described herein. The method 700 can begin at 702 where the multimedia content requestor registers an account, and at 704, the requestor can place a request for video. At this time, the multimedia sharing platform can optionally initiate partial payment at 706 and if the order is cancelled, the payment can be cancelled and the money returned at 708.

At 710, the multimedia content requestor can receive an offer from the content producer to fulfill the multimedia content request, and can either accept or decline the offer. If the offer is accepted at 712, then the order is reserved by the content producer at 714. If the content requestor cancels the order at 716, the requestor may be fined up to 50% of the order price. If the requestor does not cancel however, and watches the broadcast at 720 and finds the broadcast satisfactory at 722, then the rights to the video and/or audio can be transferred to the requestor at 726. If the requestor does not find the multimedia content satisfactory, then the parties can undergo arbitrage at 724.

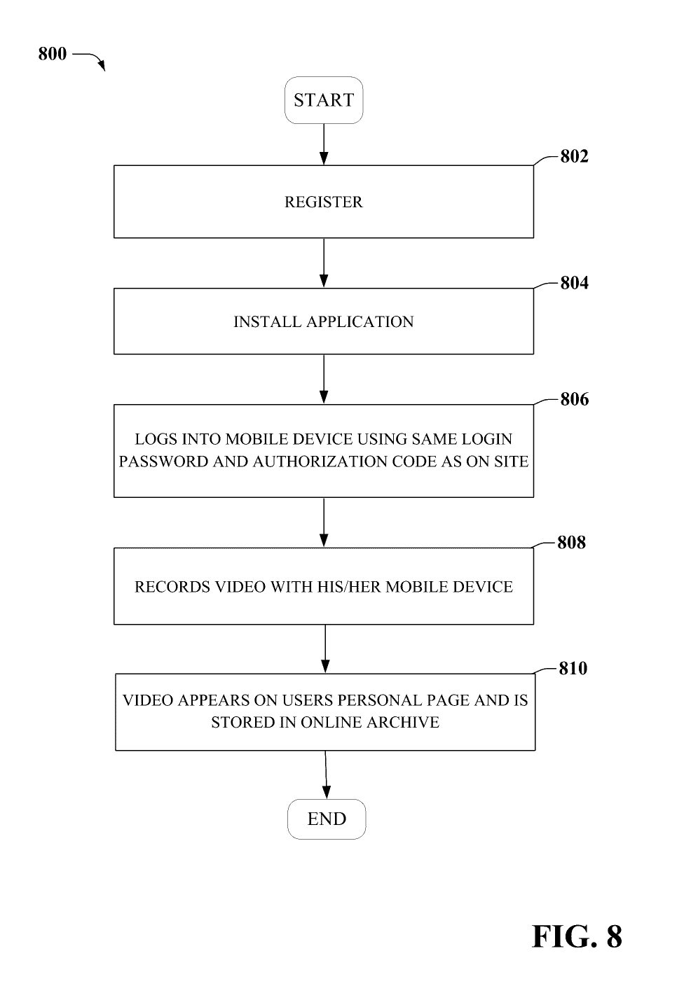

Turning now to FIG. 8, illustrated is another flow diagram of an example, non-limiting embodiment of a method 800 for sharing and distributing multimedia content for users operating outside the order system as described herein. The user outside the order system can register for an account at 802, install the application at 804, and then log into the application on the mobile device using the same password and authorization code as on the website which they registered for an account at 806. At 808, the user can record a video or other multimedia content with the user's mobile device, and instead of directly being streamed to another user, can be tagged with metadata describing the location and time, and other relevant information about the multimedia and can be stored in an online archive and linked to their account and shown on their personal page as shown at 810. From there, if a requestor makes a request for a video that matches the metadata associated with the recorded multimedia, that already recorded multimedia can be offered in place of multimedia made to order.

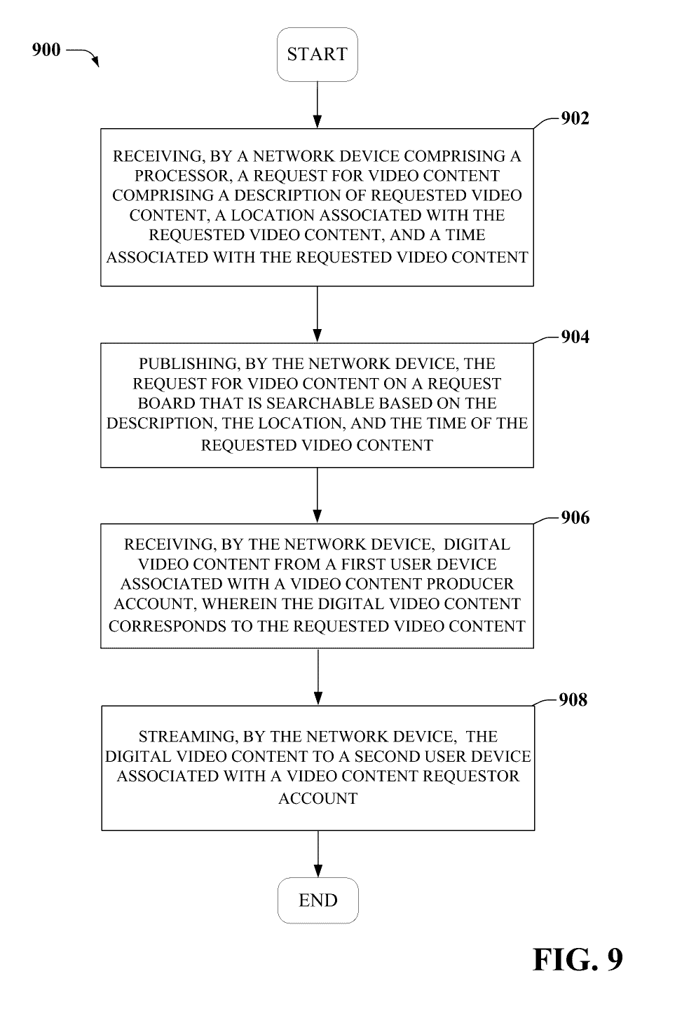

FIG. 9 illustrates a flow diagram of an example, non-limiting embodiment of a method 900 for sharing and distributing multimedia content as described herein

Method 900 can begin at 902 where the method includes receiving, by a network device comprising a processor, a request for video content comprising a description of requested video content, a location associated with the requested video content, and a time associated with the requested video content.

At method step 904, the method includes publishing, by the network device, the request for video content on a request board that is searchable based on the description, the location, and the time of the requested video content. At 906, the method includes receiving, by the network device, digital video content from a first user device associated with a video content producer account, wherein the digital video content corresponds to the requested video content. At 908, the method includes streaming, by the network device, the digital video content to a second user device associated with a video content requestor account.

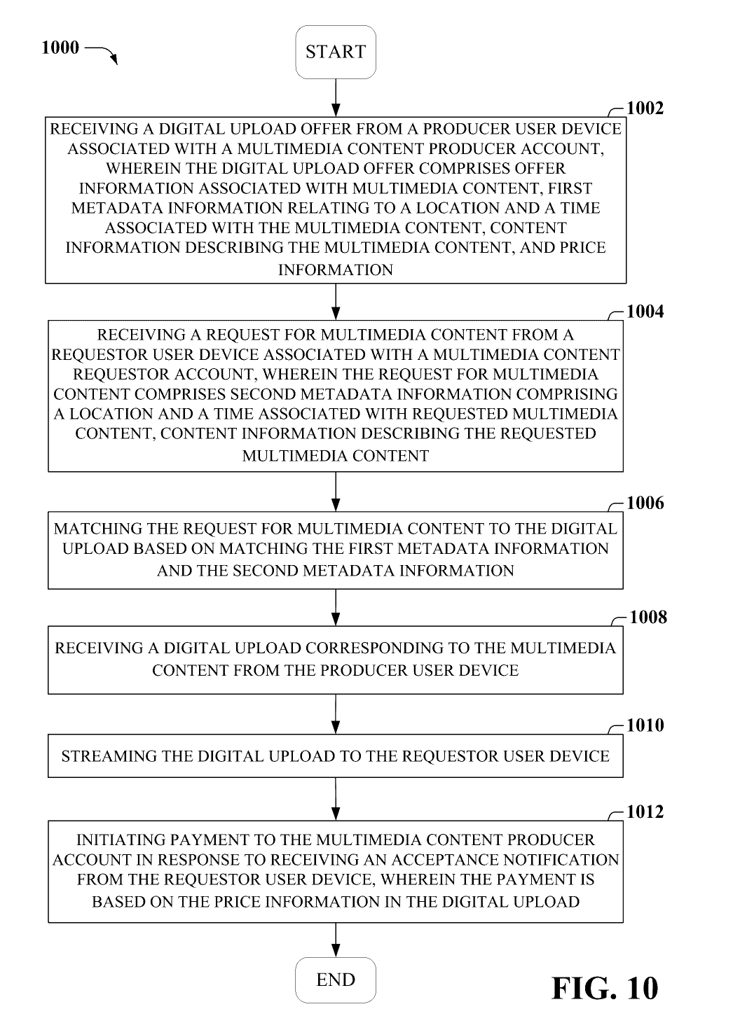

FIG. 10 illustrates a flow diagram of an example, non-limiting embodiment of a method 1000 for sharing and distributing multimedia content as described herein

Method 1000 can begin at 1002, where the method includes receiving a digital upload offer from a producer user device associated with a multimedia content producer account, wherein the digital upload offer comprises offer information associated with multimedia content, first metadata information relating to a location and a time associated with the multimedia content, content information describing the multimedia content, and price information. At 1004, the method can include receiving a request for multimedia content from a requestor user device associated with a multimedia content requestor account, wherein the request for multimedia content comprises second metadata information comprising a location and a time associated with requested multimedia content, content information describing the requested multimedia content. At 1006, the method can include matching the request for multimedia content to the digital upload based on matching the first metadata information and the second metadata information.

At 1008, the method can include receiving a digital upload corresponding to the multimedia content from the producer user device and at 1010, the method can include streaming the digital upload to the requestor user device. At 1012, the method can include initiating payment to the multimedia content producer account in response to receiving an acceptance notification from the requestor user device, wherein the payment is based on the price information in the digital upload.

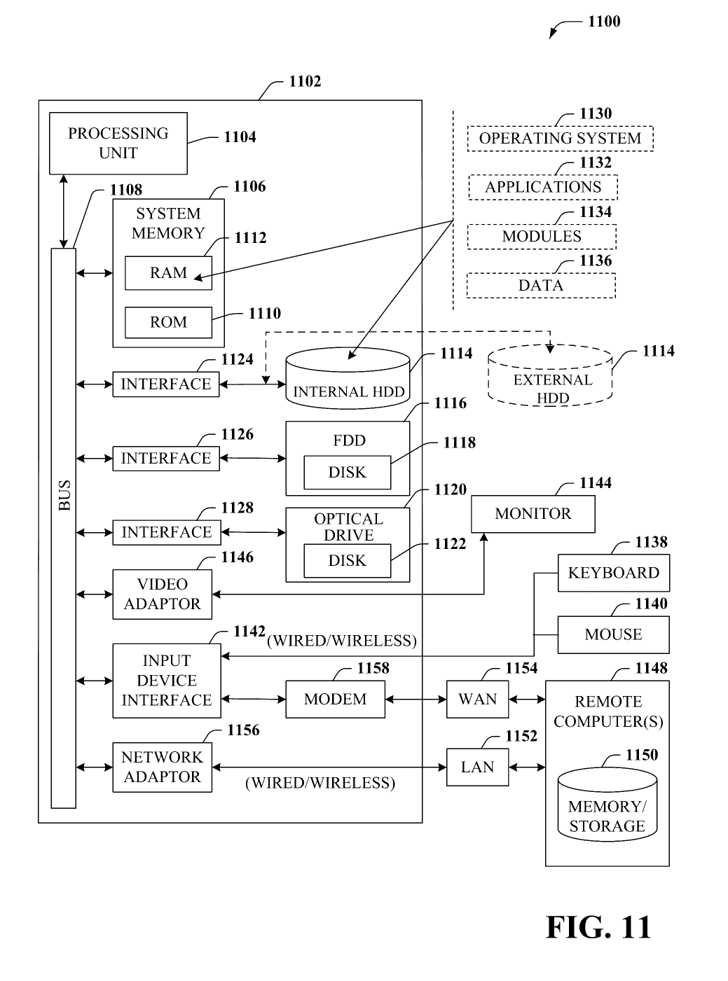

Referring now to FIG. 11, there is illustrated a block diagram of a computing environment in accordance with various aspects described herein. For example, in some embodiments, the computer can be or be included within the multimedia sharing and distribution platform disclosed here in in any of the previous systems 110, 200, 300, 400, and/or 500.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1111 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) can include a microphone, an infrared (IR) remote control, a joystick, a game pad, a stylus pen, touch screen or the like. These and other input devices are often connected to the processing unit 1104 through an input device interface 1142 that can be coupled to the system bus 1108, but can be connected by other interfaces, such as a parallel port, an IEEE 1394 serial port, a game port, a universal serial bus (USB) port, an IR interface, etc.

A monitor 1144 or other type of display device can be also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1152 through a wired and/or wireless communication network interface or adapter 1156. The adapter 1156 can facilitate wired or wireless communication to the LAN 1152, which can also include a wireless AP disposed thereon for communicating with the wireless adapter 1156.

When used in a WAN networking environment, the computer 1102 can include a modem 1158 or can be connected to a communications server on the WAN 1154 or has other means for establishing communications over the WAN 1154, such as by way of the Internet. The modem 1158, which can be internal or external and a wired or wireless device, can be connected to the system bus 1108 via the input device interface 1142. In a networked environment, program modules depicted relative to the computer 1102 or portions thereof, can be stored in the remote memory/storage device 1150. It will be appreciated that the network connections shown are example and other means of establishing a communications link between the computers can be used.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 11 BaseT wired Ethernet networks used in many offices.

In an embodiment of the subject application, the computer 1102 can provide the environment and/or setting in which one or more of the multimedia sharing systems 110-500 shown in FIGS. 1-5 can be operated from.

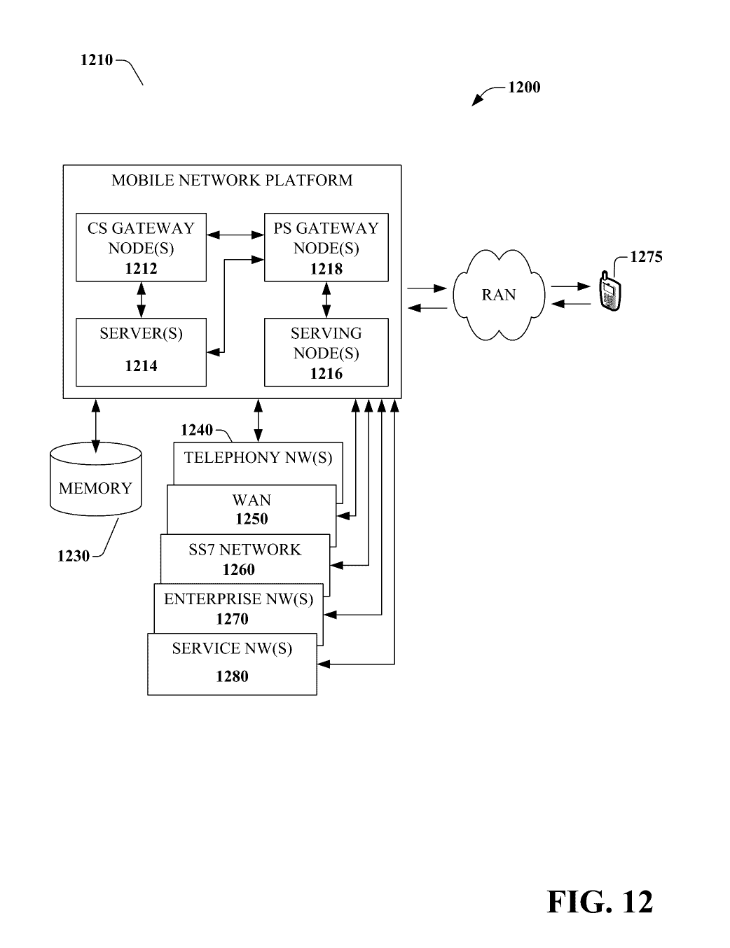

FIG. 12 presents an example embodiment 1200 of a mobile network platform 1210 that can implement and exploit one or more aspects of the disclosed subject matter described herein. Generally, wireless network platform 1210 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1210 can be included in telecommunications carrier networks, and can be considered carrier-side components as discussed elsewhere herein. Mobile network platform 1210 includes CS gateway node(s) 1212 which can interface CS traffic received from legacy networks like telephony network(s) 1240 (e.g., public switched telephone network (PSTN), or public land mobile network (PLMN)) or a signaling system #7 (SS7) network 1270. Circuit switched gateway node(s) 1212 can authorize and authenticate traffic (e.g., voice) arising from such networks. Additionally, CS gateway node(s) 1212 can access mobility, or roaming, data generated through SS7 network 1270; for instance, mobility data stored in a visited location register (VLR), which can reside in memory 1230. Moreover, CS gateway node(s) 1212 interfaces CS-based traffic and signaling and PS gateway node(s) 1218. As an example, in a 3GPP UMTS network, CS gateway node(s) 1212 can be realized at least in part in gateway GPRS support node(s) (GGSN). It should be appreciated that functionality and specific operation of CS gateway node(s) 1212, PS gateway node(s) 1218, and serving node(s) 1216, is provided and dictated by radio technology(ies) utilized by mobile network platform 1210 for telecommunication. Mobile network platform 1210 can also include the MMEs, HSS/PCRFs, SGWs, and PGWs disclosed herein.

In addition to receiving and processing CS-switched traffic and signaling, PS gateway node(s) 1218 can authorize and authenticate PS-based data sessions with served mobile devices. Data sessions can include traffic, or content(s), exchanged with networks external to the wireless network platform 1210, like wide area network(s) (WANs) 1250, enterprise network(s) 1270, and service network(s) 1280, which can be embodied in local area network(s) (LANs), can also be interfaced with mobile network platform 1210 through PS gateway node(s) 1218. It is to be noted that WANs 1250 and enterprise network(s) 1260 can embody, at least in part, a service network(s) like IP multimedia subsystem (IMS). Based on radio technology layer(s) available in technology resource(s) 1217, packet-switched gateway node(s) 1218 can generate packet data protocol contexts when a data session is established; other data structures that facilitate routing of packetized data also can be generated. To that end, in an aspect, PS gateway node(s) 1218 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1200, wireless network platform 1210 also includes serving node(s) 1216 that, based upon available radio technology layer(s) within technology resource(s) 1217, convey the various packetized flows of data streams received through PS gateway node(s) 1218. It is to be noted that for technology resource(s) 1217 that rely primarily on CS communication, server node(s) can deliver traffic without reliance on PS gateway node(s) 1218; for example, server node(s) can embody at least in part a mobile switching center. As an example, in a 3GPP UMTS network, serving node(s) 1216 can be embodied in serving GPRS support node(s) (SGSN).

For radio technologies that exploit packetized communication, server(s) 1214 in wireless network platform 1210 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1210. Data streams (e.g., content(s) that are part of a voice call or data session) can be conveyed to PS gateway node(s) 1218 for authorization/authentication and initiation of a data session, and to serving node(s) 1216 for communication thereafter. In addition to application server, server(s) 1214 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1210 to ensure network's operation and data integrity in addition to authorization and authentication procedures that CS gateway node(s) 1212 and PS gateway node(s) 1218 can enact. Moreover, provisioning server(s) can provision services from external network(s) like networks operated by a disparate service provider; for instance, WAN 1250 or Global Positioning System (GPS) network(s) (not shown). Provisioning server(s) can also provision coverage through networks associated to wireless network platform 1210 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1275.

It is to be noted that server(s) 1214 can include one or more processors configured to confer at least in part the functionality of macro network platform 1210. To that end, the one or more processor can execute code instructions stored in memory 1230, for example. It is should be appreciated that server(s) 1214 can include a content manager 1215, which operates in substantially the same manner as described hereinbefore.

In example embodiment 1200, memory 1230 can store information related to operation of wireless network platform 1210. Other operational information can include provisioning information of mobile devices served through wireless platform network 1210, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1230 can also store information from at least one of telephony network(s) 1240, WAN 1250, enterprise network(s) 1260, or SS7 network 1270. In an aspect, memory 1230 can be, for example, accessed as part of a data store component or as a remotely connected memory store.

In order to provide a context for the various aspects of the disclosed subject matter, FIGS. 11 and 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory (see below), non-volatile memory (see below), disk storage (see below), and memory storage (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, field programmable gate array, graphics processor, or software defined radio reconfigurable processor and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of the each cell site of the acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As used in this application, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a processor; and
a memory that stores executable instructions that, when executed by the processor, facilitate performance of operations, comprising:
receiving a request for multimedia content, wherein the request comprises location information indicative of a geographic location associated with the request for the multimedia content, time information indicative of a specified time to begin recording the multimedia content at the geographic location, content information describing the requested multimedia content, and reward information;
forwarding the request to a set of multimedia content producers, wherein the set of multimedia content producers is determined based on matching or substantially matching a set of locations of the set of multimedia content producers to the location information in the request for the multimedia content;
receiving, via a digital upload from a producer user device associated with a multimedia content producer of the set of multimedia content producers, multimedia content associated with the request for the multimedia content;
streaming the digital multimedia content to a requestor user device of a user account associated with the request for the multimedia content; and
initiating payment to the multimedia content producer in response to receiving the digital upload by the requestor user device, wherein the payment is based on the reward information in the request for the multimedia content.

2. The system of claim 1, wherein the set of multimedia content producers is further determined based on quality scores of each respective multimedia content producers, wherein the quality scores are based on quality feedback of previous multimedia content uploaded by the set of multimedia content producers.

3. The system of claim 1, wherein the operations further comprise:
ranking the digital multimedia content based on a quality of the digital multimedia content.

4. The system of claim 1, wherein the operations further comprise:
receiving a notification comprising an acceptance of the request for the multimedia content from the multimedia content producer and forwarding the notification comprising the acceptance to the requestor user device.

5. The system of claim 1, wherein the digital multimedia content comprises video and audio content.

6. The system of claim 1, wherein the operations further comprise:
sending an alert to the requestor user device in response to the request for the multimedia content being unfulfilled for a predefined time period.

7. The system of claim 1, wherein the operations further comprise:
sending an alert to the requestor user device in response to the request for the multimedia content being unfulfilled based on the time information.

8. The system of claim 1, wherein the operations further comprise:
sending an alert to the producer user device in response to the request for the multimedia content being unfulfilled for a predefined time period.

9. The system of claim 1, wherein the operations further comprise:
sending an alert to the producer user device in response to the request for the multimedia content being unfulfilled based on the time information specified in the request.

10. The system of claim 1, wherein the forwarding the request to the set of multimedia content producers comprises forwarding a notification to the set of multimedia content producers comprising a plurality of requests for multimedia content, and wherein the plurality of requests for multimedia content conform to a filter setting received from the requestor user device.

11. The system of claim 1, wherein the specified time to begin the recording of the multimedia content is a future time with respect to a time associated with the request.

12. The system of claim 1, wherein the operations further comprise:
receiving sensor data from the producer user device and streaming the sensor data to the requestor user device.

13. The system of claim 12, wherein the sensor data includes motion data and external environment condition data.

14. The system of claim 1, wherein the operations further comprise:
during the streaming of the digital multimedia content, receiving an instruction related to an operation of the producer user device with respect to the digital multimedia content captured by the producer user device; and
streaming a modified version of the digital multimedia content in response to the instruction.

15. The system of claim 14, wherein the instruction comprises a control signal configured to adjust an operation of the producer user device.

16. The system of claim 15, wherein the instruction is in response to a notification received from the producer user device ceding control of the producer user device to the requestor user device.

17. The system of claim 1, wherein the operations further comprise:
combining the digital upload with another digital upload from a second producer user device associated with another multimedia content producer to form a combined digital upload, and wherein the streaming comprises streaming the combined digital upload to the requestor user device.

18. The system of claim 1, wherein the operations further comprise:
matching a prior digital multimedia content from the multimedia content producer to a style classification type; and
selecting the multimedia content producer to the set of multimedia content producers based on the style classification type.

19. The system of claim 1, wherein the content information comprises a request for real-time streaming.

20. A method, comprising:
receiving, by a network device comprising a processor, a request for video content comprising description data indicative of a description of requested video content, location data indicative of a location associated with the requested video content, and time data indicative of a time to start recording the requested video content;
publishing, by the network device, the request for video content on a request board that is searchable based on the description data, the location data, and the time data;
receiving, by the network device, digital video content from a producer user device associated with a video content producer account, wherein the digital video content corresponds to the requested video content; and
streaming, by the network device, the digital video content to a requestor user device associated with a video content requestor account.

21. The method of claim 20, further comprising:
initiating, by the network device, payment to the video content producer account in response to receiving the digital video content from the producer user device, wherein the payment is based on reward data in the request for video content.

22. The method of claim 20, further comprising:
receiving, by the network device, a notification comprising an acceptance of the request for video content from the producer user device and forwarding the notification comprising the acceptance to the requestor user device.

23. The method of claim 20, further comprising:
sending, by the network device, an alert to the requestor user device in response to the request for video content being unfulfilled for a predefined time period.

24. The method of claim 20, further comprising:
sending an alert to the requestor user device in response to the request for video content being unfulfilled after the time associated with the time data.

25. The method of claim 20, further comprising:
receiving, by the network device, sensor data from the producer user device comprising motion data and external environment data and streaming the sensor data to the requestor user device.

26. The method of claim 20, further comprising:
receiving, by the network device, an instruction related to an operation of the producer user device from the requestor user device, wherein the instruction comprises a control signal associated with an operation of the requestor user device.

27. The method of claim 20, further comprising:
combining, by the network device, the digital video content with other digital video content from a third user device associated with another video content producer account to form a combined digital video content, and wherein the streaming comprises streaming the combined digital video content to the requestor user device.

28. The method of claim 20, wherein the time to start the recording of the requested video content is a first time, and wherein the streaming comprises streaming the digital multimedia content at a second time.

29. A non-transitory machine-readable storage medium, comprising executable instructions that, when executed by a processor, facilitate performance of operations, comprising:
receiving a request for multimedia content from a multimedia content requestor, wherein the request comprises metadata information that comprises location data relating to a location associated with the request for the multimedia content, time data relating to a defined time to begin capturing the multimedia content and content data describing the requested multimedia content;
forwarding the request to a set of multimedia content producers, wherein the set of multimedia content producers is determined based on mapping a set of locations of the set of multimedia content producers to the location data in the request for the multimedia content according to a defined closeness condition between the set of locations and the location of the location data being determined to be satisfied;
receiving a notification comprising an acceptance of the request for the multimedia content from a producer device associated with a multimedia content producer of the set of multimedia content producers and forwarding the notification comprising the acceptance to a requestor device associated with the multimedia content requestor;
receiving, via a digital upload from the producer device, multimedia content associated with the request for the multimedia content; and
streaming the digital multimedia content to the requestor device.

30. The non-transitory machine-readable storage medium of claim 29, wherein the request for the multimedia content comprises incentive data.

31. The non-transitory machine-readable storage medium of claim 30, wherein the operations further comprise:
initiating a payment to the producer device in response to receiving the digital upload from the producer device, wherein the payment is based on the incentive data in the request for the multimedia content.

32. The non-transitory machine-readable storage medium of claim 31, wherein the time data is first time data, wherein the defined time is a first defined time, wherein the request comprises second time data representative of a second defined time to begin streaming the multimedia content, and wherein the streaming comprises streaming the digital multimedia content at the second defined time.

33. A system, comprising:
a processor; and
a memory that stores executable instructions that, when executed by the processor, facilitate performance of operations, comprising:
receiving a digital upload offer from a producer user device associated with a multimedia content producer account, wherein the digital upload offer comprises offer information associated with multimedia content, first metadata information that comprises first location information indicative of a set of locations associated with the digital upload offer and first time information indicative of a set of defined times associated with the multimedia content, content information describing the multimedia content, and price information;
receiving a request for multimedia content from a requestor user device associated with a multimedia content requestor account, wherein the request for the multimedia content comprises second metadata information that comprises second location information indicative of a location associated with the request for the multimedia content, second time information indicative of a defined time to begin recording the multimedia content, and content information describing the requested multimedia content;
matching the request for the multimedia content to the digital upload based on matching the first metadata information and the second metadata information;
receiving a digital upload corresponding to the multimedia content from the producer user device;
streaming the digital upload to the requestor user device; and
initiating payment to the multimedia content producer account in response to receiving an acceptance notification from the requestor user device, wherein the payment is based on the price information in the digital upload.

34. The system of claim 33, wherein the digital upload is received from the producer user device before the digital upload offer is accepted by the requestor user device.
